(19) United States
(12) Patent Application Publication
(10) Pub. No.: US 2008/0047237 A1
(43) Pub. Date: Feb. 28, 2008

(54) Stirrups with Total Support Floor for Riders' Feet

(76) Inventor: Laurent Lantuejoul, Saint Flour (FR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/814,026

(22) PCT Filed: Mar. 15, 2005
(86) PCT No.: PCT/FR05/00617

§ 371 Date: Oct. 5, 2007

(51) Int. Cl. B68C 3/00

(52) U.S. Cl. 54/47

(57) ABSTRACT

A stirrup with a one-piece tread for front and rear support for feet, including two rear fasteners for ends of a double strap supported by a counter-strap of an adjustable stirrup leather or by a rear stirrup leather, also adjustable and attached to a shackle integral with the saddle. The front of the stirrup includes an articulated stirrup iron suspended on the stirrup leather. The rear outer fastener includes a mechanism that releases the foot laterally in the event of a fall. The broad suspension base of the stirrup with tread reduces swinging effect that develops in a traditional suspension and improves dynamic stability of the rider and ease of learning of balance for novices.

The present invention relates to a device furnishing a rider with means that greatly increase his balance on the horse, especially in what is known as the lift position.

The existing stirrups exhibit major disadvantages. The support length for the foot in existing stirrups is on the order to 3 to 4 centimeters at most. The rider inserts his feet into the stirrups at the widest part of his shoe, or in other words at the front of his feet. Since the center of gravity of his body weight passes through the vertical of his heel, and since this weight is supported on the front of the foot, the rider is constantly striving for balance when he is in the lift position, with his entire weight supported on the stirrups. Consequently, the existing stirrups do not permit the rider to achieve true stability, particularly when he is learning balance on horseback. Acquisition of mastery of such balance for a rider supported only on the front part of his feet is very difficult, very time-consuming and is always tricky, because of the fact that the feet are constantly rocking on their stirrups, themselves attached to the end of a stirrup leather that acts as a pendulum, and that in addition he must vertically follow the movements of the horse that disturb his balance. Moreover, this continuous striving for balance is fatiguing, because it causes muscle contractions that cause a change of position of the rider harmful to himself and the horse.

In the event of a fall from the horse, it frequently happens that one of the feet remains caught in its corresponding stirrup. As a result, the rider is dragged along the ground when the horse continues its course.

To overcome these disadvantages, the following problems must be solved:

To reduce significantly the time for the rider to acquire mastery of dynamic balance while learning, which at best currently takes approximately one year, it is necessary to provide him with more stable support in his stirrups than is the case of current stirrups, so that he can master the composition of the following three movements more rapidly: rocking and flexing movements of the ankle that occur continuously, to follow the movements of the horse while maintaining his dynamic balance; swinging movement from the point of fastening of the stirrup leather to its stirrup bar; vertical movement to follow the movements of the horse.

To ensure that a rider who has fallen from the horse is not dragged thereby by a leg whose foot has remained caught in the corresponding stirrup, the rider's foot must be able to separate automatically from the stirrup under the force caused by the fall.

The problems thus posed are fully resolved by means of the stirrups according to the invention and by the corresponding saddle. These stirrups with total support tread for the feet of riders permit them to have more stable support on their horse. They are each provided with a tread that extends over the entire length of the rider's shoe, supported by one stirrup leather at the front part and supported by a second stirrup leather at the rear.

According to a first embodiment, the front stirrup leather supports a stirrup iron articulated on the front sides of the stirrup cooperating with a double strap at the rear. The rear stirrup leather is formed by the counter-strap of the front stirrup leather passing through the stirrup bar integral with the saddle, and it supports a double strap fixed on two lateral fasteners integral with the rear of the stirrup. The front stirrup leather and the rear double strap include adjustment of the inclination of the tread. The front stirrup leather and its counter-strap are mounted in sliding or fixed manner on the stirrup bar of the saddle. The stirrup leather counter-strap is engaged in a belt loop with which the support position of the stirrup can be broadened.

According to an alternative embodiment, the rear stirrup leather is fixed in removable relationship on a metal U-shaped shackle whose wide ends are drilled by a hole in which there engages a metal rod with head passing into the loop of the stirrup leather, this rod being immobilized by a small split pin or any other known means; the U-shaped shackle is made integral with the saddle by a thong stitched thereon.

According to a first embodiment, the stirrup with tread is made in two parts equipped with a slide for adjusting the length as a function of the size of the rider's feet and with upwardly bent sides, as well as with fasteners for front and rear stirrup leathers.

According to a second embodiment, the stirrup with total support tread is made of a single metal sheet provided with two upwardly bent sides and holes for fixation of different fasteners for stirrup leathers and double straps; they have several lengths and widths to cover all sizes.

According to a first version of the equipment of the said stirrup, it is provided with a stirrup iron articulated on its front sides and with two lateral fasteners for the double strap at the rear.

Especially for novice riders, the outer rear fastener is equipped with an elastically deformable release means permitting the double strap to separate from the outer side on the horse in the event of a fall.

According to a first embodiment, the elastically deformable release means is made of a leaf spring bent in U-shape, each end being provided on the inside with a hollow indentation in which there are engaged the hemispherical ends of a rod, over which there is passed the corresponding end of the strap.

According to a second embodiment, the elastically deformable release means is made of a rod receiving the corresponding end of the strap and is engaged in the hollow indentation of a portion of a square angle piece integral with the stirrup and in the indentation of the end of a pusher sliding in a block pushed by a compression spring, itself adjustable according to the weight of the rider, by means of a screw acting on the stiffness of the spring, the block being fixed by a screw under the stirrup.

According to a third embodiment, the elastically deformable release means is made of spring leafs acting on a metal strap shackle to maintain it in normally captive position and cooperating with at least one complementary spring leaf to adjust the stiffness of maintenance of the shackle as a function of the weight of the rider.

According to a fourth embodiment, the elastically deformable release means is made of a downwardly bent metal rod whose one end is welded to the stirrup, the end of the strap has a hole reinforced by an eyelet engaged on the bent part of the rod which can be slightly curved and is maintained by a leaf spring fixed on a portion of an angle piece integral with the underside of the stirrup.

According to a second version of the equipment of the said stirrup, the rear stirrup leather is made integral with a stirrup iron articulated on an elastically deformable release means, which is provided with a spring pusher and cooperates at the front of the said stirrup with another articulated stirrup iron.

According to a first embodiment, the removable fasteners of the stirrup leather and strap are made of a block containing an aperture for passage of a stirrup leather or of a strap attached on a rod engaged with slight play in a hole drilled in the parts of the block, the rod being immobilized on the block after the stirrup leather has been put in place.

According to a second embodiment, the front, rear or lateral fasteners of the stirrup leather and strap fixed on the said stirrup with tread have the form of a bent metal sheet, which is provided with an opening with rounded edges for the passage of a stirrup leather or of a double strap and with two holes on its lower bend, for fixation to the bottom or top of the stirrup depending on its positioning thereon.

According to a third embodiment, the front, rear or lateral fasteners of the stirrup leather and strap are machined directly on a stirrup with tread by cutting and rounding the edges so that the strap and stirrup leather can be received directly.

The saddle is equipped with two pairs of stirrup bars, each pair being spaced apart by the maximum to receive the front and rear stirrup leathers.

According to a third version, the equipment of the said stirrup has a removable fastener at the front and rear.

According to a fourth version of the equipment of the said stirrup, it has a removable fastener at the front and a second lateral fastener at the rear cooperating with an elastically deformable release fastener.

According to a fifth version for modular and developmental equipment of the said stirrup, it has multiple perforations for fixation of the diverse types of removable front and rear stirrup leather fasteners having elastic release, and for fixation of the front stirrup leather fastener taking into account the developmental height of the rider.

The advantages achieved by the stirrup-saddle combination according to the invention are the following:

The stirrups with front and rear foot support offer excellent stability to the rider, at best when his entire weight rests on the stirrups in lift position; as a result, the learning time for novices to master balance during lift is shortened from approximately one year to a mere few hours; all that then remains is for the rider to learn to “pump” around a medium position to follow the movements of his horse with very much less fatigue, since he no longer has to assure his balance simultaneously.

In the event of a fall, the rider's foot is released from the stirrup, and he no longer runs the risk of being dragged by his horse.

They offer comfort and safety for handicapped riders.

In the disciplines of endurance, obstacle jumping, cross country and trotting races they make it possible to optimize the performances.

For horseback tours, they greatly increase the comfort and safety while reducing the fatigue.

They permit better distribution of the rider's weight over the horse's back, thus leading to better locomotion of the horse.

The invention will be better understood by reading the description hereinafter, given with reference to figures illustrating the invention non-limitatively, wherein:

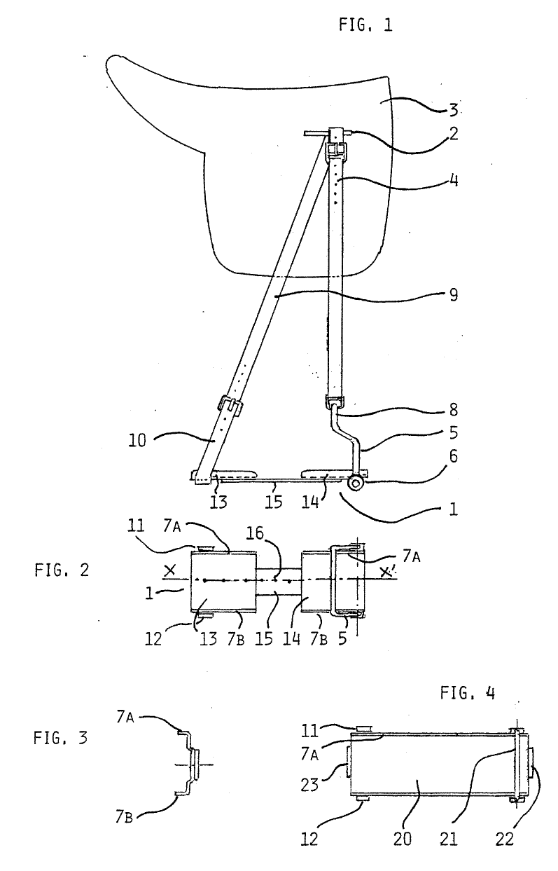

FIGS. 1, 2 and 3 show, in elevation, in a view from above and in an end-on view, a first embodiment of the stirrup with tread and its attachment to the saddle according to the invention, with size of adjustable length;

FIG. 4 shows a second embodiment of a stirrup with one-piece tread;

FIG. 5 shows a second mode of attachment of the stirrup with tread to a saddle;

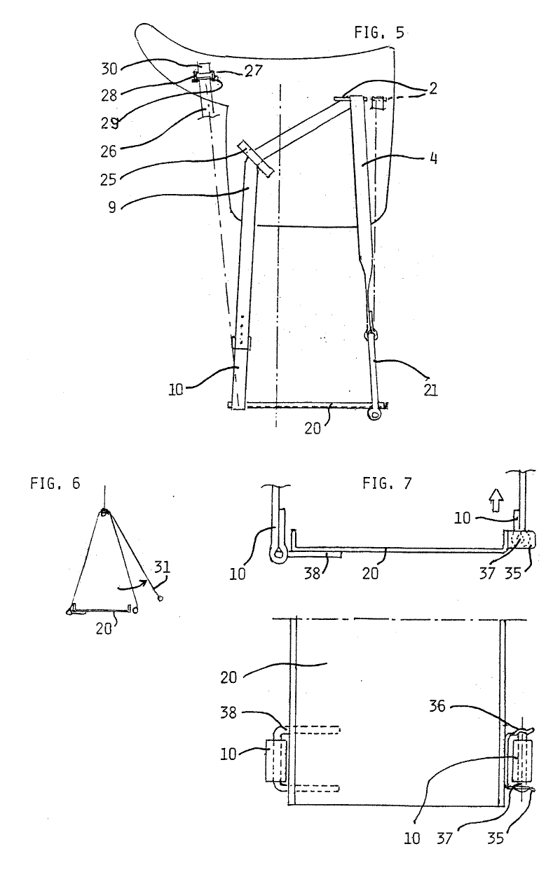

FIG. 6 schematically shows the lateral detachment of the outer strap of the stirrup with tread during a fall in order to release the rider's foot;

FIGS. 7 and 8 show, in views end-on and from above, a stirrup with tread equipped with a spring fastener releasing the rider's foot in the event of a fall;

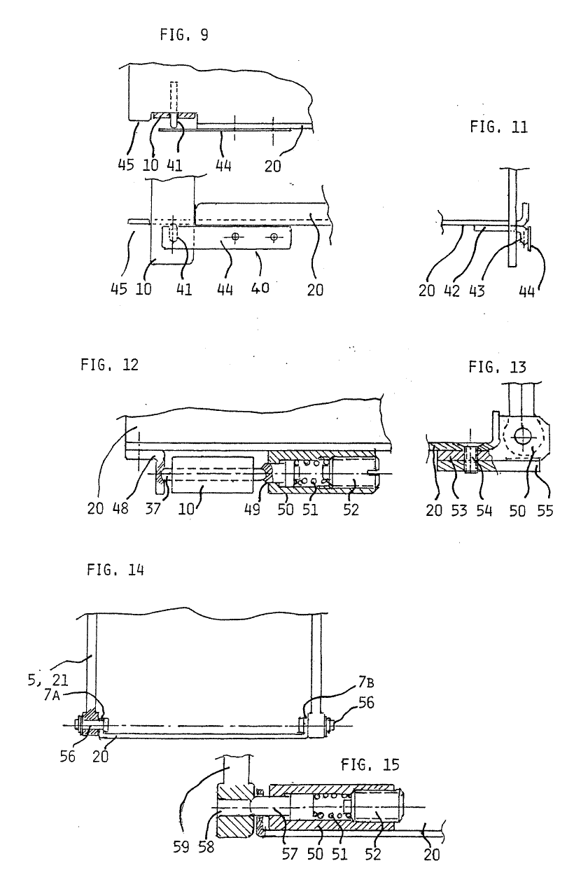

FIGS. 9, 10 and 11 show, in views from the side, from above and end-on, a stirrup with tread equipped with a spring fastener releasing the rider's foot in the event of a fall;

FIGS. 12 and 13 show views in section and end-on of an elastic means for releasing the foot of a rider, mounted on the side of a stirrup with tread;

FIGS. 14 and 15 show views in section of a means of elastic release of a rear stirrup iron maintaining the rear of the foot of a rider equipped with a stirrup with tread;

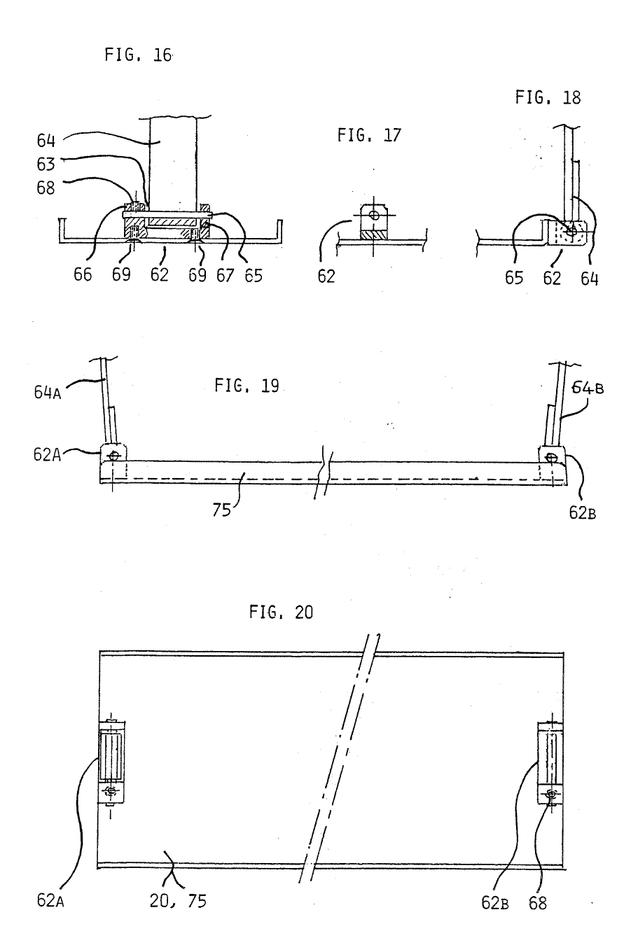

FIGS. 16 to 18 show views in section and end-on of a removable means for fixation of a stirrup leather on a stirrup with tread;

FIGS. 19 and 20 show views from the side and above of a third embodiment of a stirrup with tread containing a removable front fastener and a removable rear fastener;

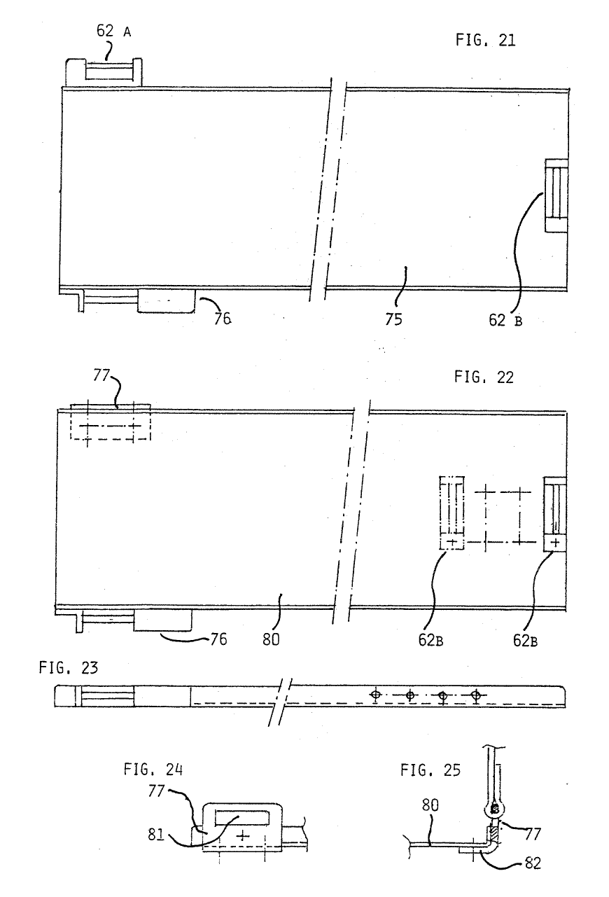

FIG. 21 shows a view from above of a fourth embodiment of the stirrup with tread containing a front stirrup leather fastener, a left rear fastener and a right rear fastener with elastic release;

FIGS. 22 and 23 show views from the side and above of a fifth embodiment of a stirrup with tread of developmental and modular type, provided with multiple perforations making it possible to fix various types of removable and elastically releasing front and rear stirrup leather fasteners and to fix the front fastener as a function of the height of the rider;

FIGS. 24 and 25 show an alternative version of the front, rear or lateral fastener for fixation to a stirrup with tread;

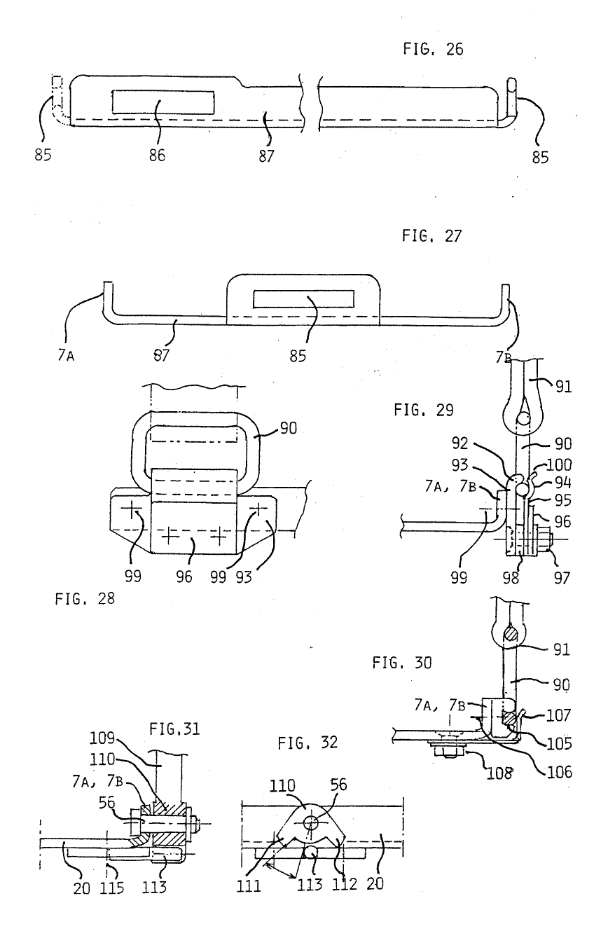

FIGS. 26 and 27 show an alternative version of the front, rear or lateral fastener machined directly on a stirrup with tread;

FIGS. 28 and 29 show a fifth alternative version of a stirrup leather shackle fastener that releases elastically in the event of a fall, mounted on the rear side of a stirrup with tread;

FIG. 30 shows a sixth alternative version of a stirrup leather shackle fastener that releases elastically in the event of a fall, mounted on the rear side of a stirrup with tread;

FIGS. 31 and 32 show an example of stops for limiting the inclination of the stirrup while obstacle jumping.

FIGS. 1, 2 and 3 show, in elevation, in a view from above and in an end-on view, a first embodiment of stirrup with tread 1 with size adjustable in length and its attachment to stirrup bar 2 of saddle 3 by an adjustable stirrup leather 4 attached at one end to the top of a stirrup iron 5 articulated at 6 on the front sides 7 of tread 1. Stirrup iron 5 is backwardly bent at 8 in such a way that the stirrup leather is disposed in the vertical of stirrup bar 2. Counter-strap 9 of stirrup leather 4 is connected to a double strap 10 fixed on two lateral fasteners 11 and 12 at the rear of the tread. Tread 1 is made in two sheet-metal parts 13 and 14, each provided with two upwardly bent sides 7a and 7b holding the rider's shoe. The two parts 13 and 14 are made integral with one another, for example by means of a plate 15 that can be reinforced by lateral bends and that is provided in longitudinal axis XX′ of the tread with a row of holes 16 for adjustable fixation on parts 13, 14, provided with corresponding holes, which holes can be replaced by slots for continuous size adjustment. FIG. 3 shows an example of the tread viewed end-on, provided with a double central bend offset relative to the support surface of the foot, permitting the use of a headed screw for size adjustment without impairing the support for the foot. In this type of stirrup with tread, the rider's foot is supported at both the front and back. This first mode of suspension of the stirrup with tread does not change the swinging movement of the stirrup relative to stirrup bar 2.

FIGS. 4 and 5 show, in views from above and in elevation, a second mode of suspension of a stirrup with one-piece tread 20 made, for example, in 4 different sizes (in length and in width) and having the same fasteners as in FIG. 2. There has been added a front stop 22 formed by an upward bend and an identical stop 23 at the rear for riders who do not use spurs. The tread is supported at the front by a plane stirrup iron 21 articulated as in FIG. 1. The rear suspension of the stirrup with tread is achieved by engaging stirrup leather counter-strap 9 in a belt loop 25, which is present on most saddles, with the effect of broadening the suspension base of the stirrup with tread while reducing the swinging effect that develops in the suspension of FIG. 1. This swinging effect can be further reduced by broadening the suspension base even more at the level of the saddle, by spacing fastener points 25 and 2 farther apart. In this case, belt loop 25 is replaced by a U-shaped shackle 27, whose broadened ends 28 are drilled with a hole in which there is engaged a headed metal rod 29 of a second stirrup leather 26 passing into the shackle, this rod being immobilized by a small split pin or any other known means. The stirrup bar can be replaced by this same type of open shackle fixed by a thong 30 stitched onto the saddle. This broader suspension base of the stirrup improves the balance of novices.

FIG. 6 schematically shows the lateral detachment of the outer strap 31 of the stirrup with tread to release the rider's foot during a fall.

FIGS. 7 and 8 show, in views end-on and from above, a stirrup with tread 20 equipped with a spring fastener 35 that releases the rider's foot in the event of a fall. This first version of fastener 35 is made of a U-shaped spring-steel strip, each of whose ends is provided on the inside with a hollow indentation 36 in which there are engaged the hemispherical ends of a rod 37 over which there is passed the corresponding end of strap 10. Fixed fastener 38 is made, for example, from an open shackle welded to the stirrup.

FIGS. 9, 10 and 11 show, in views from the side, from above and end-on, a stirrup with tread equipped with a second version of a spring fastener releasing the rider's foot in the event of a fall. This fastener 40 is made of a downwardly bent metal rod 41, one end 42 of which is welded under the stirrup. The end of the strap is provided with a hole reinforced by an eyelet engaged on the bent part 43 of the rod, which may be slightly curved. To prevent the strap from becoming detached in untimely manner, for example while jumping an obstacle, there has been added a leaf spring 44 fixed on an angle portion integral with the bottom of the stirrup. The strap is maintained laterally in a notch 45 of the rear of the stirrup.

FIGS. 12 and 13 show views in section and end-on of a third version of elastic means for releasing the foot of a rider mounted on the side of a stirrup with tread. This means is composed of a rod 37 receiving the corresponding end of strap 10; rod 37 is engaged in the hollow indentation of a portion 48 of a square angle piece integral with the stirrup and in the indentation of the end of a pusher 49 sliding in a block 50 pushed by a compression spring 51, itself adjustable according to the rider's weight by means of a screw 52 acting on the stiffness of the spring. Block 50 has an extension 53 fixed under the stirrup by means of screw 54. During a fall, the abrupt force acting on rod 37 causes its ends to come out of the indentations by compressing spring 51, thus releasing the foot. The stiffness of spring 51 is adjusted by means of a traction dynamometer on the strap as a function of the rider's weight. A plate 55 fixed on block 50 ensures that elastic release of the rear strap is exclusively lateral, as is important on completing an obstacle jump to prevent the strap from releasing downward.

FIG. 14 shows a view in section of an example of articulation of the stirrup irons of FIGS. 2, 4 and 5, wherein the stirrup ironed part is constituted in the same way as that of traditional stirrups. The hubs are drilled with a hole for passage of a spindle 56 provided with a head, engaged in a corresponding hole of bends 7a, 7b of the stirrup with tread 20, spindles 56 being immobilized by a clip.

FIG. 15 shows a view in section of a means for elastic release of a rear stirrup iron maintaining the rear of the foot of a rider equipped with a stirrup with tread. The means for releasing the stirrup iron is formed by two assemblies of the type of that in FIG. 12, but pusher 57 thereof is braced either on an indentation as in FIG. 12 or on a seat formed by a chamfer machined on a hole 58 drilled in the two hubs of stirrup iron 59.

FIGS. 16 to 18 show views in section and end-on of a removable means for fixation or fastening on a stirrup with tread 20, of a stirrup leather forming a stitched loop, comprising a block 62 containing an aperture 63 for passage of a stirrup leather 64 or of a strap attached to a rod 65 engaged with slight play in a hole drilled in parts 66 and 67 of block 62, the rod being immobilized after the stirrup leather has been put in place by means of a screw 68 that tightens onto the rod. This fastener can be fixed at various front and rear locations of the stirrup, as will be shown in FIGS. 19 to 22, or on the side of bend 7a, 7b, as in FIG. 18.

FIGS. 19 and 20 show views from the side and above of a third mode of equipping stirrup 75 with tread, comprising removable front fastener 62a and rear fastener 62b, supported by rear and front stirrup leathers 64a and 64b respectively, fixed to the top of the stirrup by two milled-head screws 69 or other means, these two blocks 64 forming a rear stop and front stop for the rider's shoe, boot or other footwear.

FIG. 21 shows, in a view from above, a fourth mode of equipping a stirrup with tread for riders wearing spurs, comprising a front fastener 62b of stirrup leather 64b as in FIG. 20, with the exception that rear fastener 62a is mounted on bend 7a or 7b according to the right or left side, and a rear fastener with elastic release, for example 76 (FIG. 12, 13) mounted on the rear bend opposite that of the fixed strap.

FIGS. 22 and 23 show views from above and the side of a fifth mode of equipping the stirrup with tread of developmental and modular type, comprising multiple perforations for fixing the diverse types of removable front and rear stirrup leather fasteners having elastic release, and for fixing the front fastener in a position taking into account the developmental height of the rider. In this way it is possible to assemble, on the modular stirrup with tread having base 80, a front fastener 62b according to the size of his foot, either at the end or at one or the other of the positions represented by the axes of perforation of the fixation holes. The rear perforations make it possible to fix a fastener 62a as in FIG. 20 or as in FIG. 21, or a fastener 77 as in FIGS. 24, 25, or a fastener with elastic release 76 or, for skilled riders, a second fastener 77 or 62a.

FIGS. 24 and 25 show an alternative version of front, rear or lateral fastener 77 fixed to a stirrup with tread. It has the form of a bent metal sheet provided with an opening having rounded edges 81 for passage of a stirrup leather or of a double strap, and with two holes on its lower bend 82, for fixation on the bottom or top of the stirrup depending on its placement.

FIGS. 26 and 27 show an alternative version of front and rear fasteners 85 or lateral fastener 86, machined directly on a stirrup with tread 87 by cutting and rounding the edges so that the strap and stirrup leather can be received directly.

FIGS. 28 and 29 show a fifth alternative version of fastening of the stirrup leather shackle with elastic release in the case of a fall, mounted on the rear side of a stirrup with tread. It comprises a ring 90 of strap 91 held captively against a short rounded retaining edge 92 at the upper part of a plate 93 fixed on the rear side 7a, 7b of the stirrup by two screws 99. This edge 92 has a rounding against which there is stopped ring 90 maintained braced against preformed end 94 of a spring leaf 95 and a second spring leaf 96 for adjustment of stiffness, according to its thickness, as a function of the rider's weight. These two spring leafs are fixed to plate 93 by two bolts 97 after interposition of two spacing washers 98, thus forming an assembly that itself is fixed on the side of the stirrup by two screws 99. Ring 90 is put in place by pushing against slightly bent shoulder 100 of leaf 95.

FIG. 30 shows a sixth alternative version of fastening of the stirrup leather shackle with lateral elastic release in the event of a fall, mounted on the rear side of the stirrups with tread. It comprises a groove 105 in which there is engaged ring 90 of strap 91. This fastener is fixed by two screws 106 to side 7a, 7b of the stirrup. Lateral maintenance of ring 90 in its groove is assured by a spring leaf 107 fixed under the stirrup by two bolts 108.

FIGS. 31 and 32 show an example of stops for limiting the inclination of the stirrups with tread during obstacle jumping, comprising a stirrup iron 109 articulated at the front on a spindle 56 engaged in side 7a, 7b of the stirrup. Hub 110 is provided on the bottom, symmetrically with respect to its vertical axis, with two stops 111, 112 cooperating with a third stop 113 integral with a plate 114 fixed by screw 115 under stirrup 20.

1-23. (canceled)

24. Stirrups with total support tread for feet of riders, permitting a rider to have more stable support on a horse, each stirrup comprising:
a tread for front and rear foot support, wherein the tread is supported by one stirrup leather in a front part attached to a stirrup iron articulated on front sides of the stirrup, cooperating with a triangular double strap supported by a second stirrup leather at a rear, and wherein fixation of the front and rear stirrup leathers on the saddle are spread apart to a maximum, one toward the front and the other toward the rear.

25. Stirrups with total support tread according to claim 24, wherein the rear stirrup leather is formed by a counter-strap of the stirrup leather passing through a stirrup bar integral with the saddle, and which supports a double strap fixed on two lateral fasteners integral with the rear of the stirrup.

26. Stirrups with total support tread according to claim 24, wherein the stirrup leather and the double strap include adjustment of inclination of the tread.

27. Stirrups with total support tread according to claim 25, wherein the counter-strap of the stirrup leather passing through the front stirrup bar of the saddle is engaged in a belt loop of the saddle to broaden a rear suspension base of the stirrup.

28. Stirrups with total support tread according to claim 24, wherein the rear stirrup leather is fixed in removable relationship on a U-shaped shackle whose wide ends are drilled by a hole in which there engages a metal rod with a head passing into a stitched loop of the stirrup leather, the rod being immobilized, and wherein the U-shaped shackle is made integral with the saddle by a thong stitched thereon.

29. Stirrups with total support tread according to claim 24, wherein the stirrup with tread is made in two parts equipped with a slide for adjusting a length as a function of a size of the rider's feet and with upwardly bent sides, and with fasteners for front and rear stirrup leathers.

30. Stirrups with total support tread according to claim 24, made of a metal sheet including two upwardly bent sides and holes for fixation of different fasteners for stirrup leathers and double straps, and wherein the stirrups are made in plural lengths and widths to cover different sizes.

31. Stirrups with total support tread according to claim 24, further comprising a stirrup iron articulated on its front sides and with two lateral fasteners for the double strap at the rear.

32. Stirrups with total support tread according to claim 24, wherein an outer rear fastener includes an elastically deformable release means permitting the double strap to separate from the outer side on the horse in event of a fall.

33. Stirrups with total support tread according to claim 32, wherein the elastically deformable release means includes a leaf spring bent in U-shape, each end being provided on the inside with a hollow indentation in which there are engaged hemispherical ends of a rod, over which is passed a corresponding end of the strap.

34. Stirrups with total support tread according to claim 32, wherein the elastically deformable release means includes a rod receiving a corresponding end of the strap and engaged in a hollow indentation of a portion of a square angle piece integral with the stirrup and in an indentation of an end of a pusher sliding in a block pushed by a compression spring, itself adjustable according to weight of the rider, by a screw acting on stiffness of the spring, and wherein the block is fixed by a screw under the stirrup.

35. Stirrups with total support tread according to claim 32, wherein the elastically deformable release means includes a spring leaf acting on a metal shackle of a strap to maintain it in a normally captive position and cooperating with at least one complementary spring leaf to adjust stiffness of maintenance of the shackle as a function of weight of the rider.

36. Stirrups with total support tread according to claim 32, wherein the elastically deformable release means includes a strap fastener containing a groove in which there is engaged a ring of a strap, fixed by two screws to the rear side of the stirrup, and wherein lateral maintenance of the ring in its groove is realized by a spring leaf fixed under the stirrup by two bolts.

37. Stirrups with total support tread according to claim 32, wherein the elastically deformable release means includes a downwardly bent metal rod whose one end is welded under the stirrup, an end of the strap has a hole reinforced by an eyelet engaged on the bent part of the rod which is curved and maintained by a leaf spring fixed on a portion of an angle piece integral with the underside of the stirrup.

38. Stirrups with total support tread according to claim 24, wherein the rear stirrup leather is made integral with a stirrup iron articulated on an elastically deformable means, with a pusher with spring and adjustment screw and cooperating at the front of the stirrup with another articulated stirrup iron.

39. Stirrups with total support tread according to claim 24, wherein removable fasteners of the stirrup leather and strap are made of a block containing an aperture for passage of a stirrup leather or of a strap attached on a rod engaged with slight play in a hole drilled in the parts of the block, the rod being immobilized on the block after the stirrup leather or the strap has been put in place.

40. Stirrups with total support tread according to claim 24, wherein front, rear or lateral fasteners of the stirrup leather and strap fixed on the stirrup with tread have a form of a bent metal sheet, which includes an opening with rounded edges for passage of a stirrup leather or of a double strap and with two holes on its lower bend, for fixation to the bottom or top of the stirrup depending on its positioning thereon.

41. Stirrups with total support tread according to claim 24, wherein front and rear or lateral fasteners of the stirrup leather and strap are machined directly on a stirrup with tread by cutting and rounding the edges so that the strap or stirrup leather can be received directly.

42. Stirrups with total support tread according to claim 24, including a saddle equipped with two pairs of stirrup bars, wherein the pairs of stirrup bars are spaced apart, one by a maximum toward the front and the other by a maximum toward the rear, to receive the front and rear stirrup leathers, so as to broaden a suspension base of the stirrup leathers relative to fasteners of the stirrup leathers on the stirrups, to reduce swinging effect of the stirrups.

43. Stirrups with total support tread according to claim 24, further comprising a removable fastener at the front and at the rear.

44. Stirrups with total support tread according to claim 24, further comprising a removable fastener at the front and a second lateral fastener at the rear cooperating with an elastically deformable release fastener.

45. Stirrups with total support tread according to claim 24, further comprising multiple perforations for fixation of diverse types of removable front and rear stirrup leather fasteners having elastic release, and for fixation of the front stirrup leather fastener or an articulated stirrup iron, taking into account a developmental height of the rider.

46. Stirrups with total support tread according to claim 24, wherein the stirrup includes at the front means for limiting inclination of the tread during obstacle jumping, comprising a stirrup iron articulated at the front on two spindles engaged in the side of the stirrup, hubs of which are provided at the bottom, symmetrically with respect to their vertical axis, with two stops cooperating with a third stop integral with a plate fixed by a screw under the stirrup.
